(19) United States
(12) Patent Application Publication
(10) Pub. No.: US 2020/0335837 A1
(43) Pub. Date: Oct. 22, 2020

(54) RECHARGEABLE BATTERY INDICATOR

(71) Applicant: Jeffrey McLean, Owen Sound (CA)

(72) Inventor: Jeffrey McLean, Owen Sound (CA)

(21) Appl. No.: 16/387,126

(22) Filed: Apr. 17, 2019

(51) Int. Cl. H01M 10/48

(52) U.S. Cl. CPC H01M 10/488

(57) ABSTRACT

A rechargeable battery indictor for indicating a battery charge of a rechargeable battery is presented. The rechargeable battery indicator has a body for attaching to a rechargeable battery and has a front side, a back side, a first indicator, a second indicator, a third indicator and an indicator switch. The first indicator is indicative of a charge level of the rechargeable battery. The second indicator is indicative of a charge level of the rechargeable battery. The third indicator is indicative of a charge level of the rechargeable battery. The rechargeable battery indicator has an indicator switch, which has at least three positions. The indicator switch has a tab that is positioned to indicate the charge level of the rechargeable battery. The body also has an adhesive strip for coupling the body to the rechargeable battery. The body determines the charge level of the rechargeable battery.

### FIELD OF THE INVENTION

This invention relates to batteries. More particularly, it relates to rechargeable batteries.

### BACKGROUND

A rechargeable battery, storage battery, secondary cell, or accumulator is a type of electrical battery which can be charged, discharged into a load, and recharged many times, as opposed to a disposable or primary battery, which is supplied fully charged and discarded after use. It is composed of one or more electrochemical cells. The term “accumulator” is used as it accumulates and stores energy through a reversible electrochemical reaction. Rechargeable batteries are produced in many different shapes and sizes, ranging from button cells to megawatt systems connected to stabilize an electrical distribution network. Several different combinations of electrode materials and electrolytes are used, including lead-acid, nickel-cadmium (NiCd), nickel-metal hydride (NiMH), lithium-ion (Li-ion), and lithium-ion polymer (Li-ion polymer).

Rechargeable batteries typically initially cost more than disposable batteries, but have a much lower total cost of ownership and environmental impact, as they can be recharged inexpensively many times before they need replacing. Some rechargeable battery types are available in the same sizes and voltages as disposable types, and can be used interchangeably with them.

When the rechargeable battery types are being in use, the charge is reduced. Currently, there is not a mechanism to indicate the level of charge of the rechargeable batteries. Thus, when a user's rechargeable battery is being used, it is only when the rechargeable battery has lost charge and recharging is required. Thus, there is a need for a mechanism to indicate the charge level of a rechargeable battery prior to the battery losing charge and functionality.

### BRIEF DESCRIPTION OF THE DRAWINGS

FIG. 1 is an illustrated of an exemplary rechargeable battery indicator.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

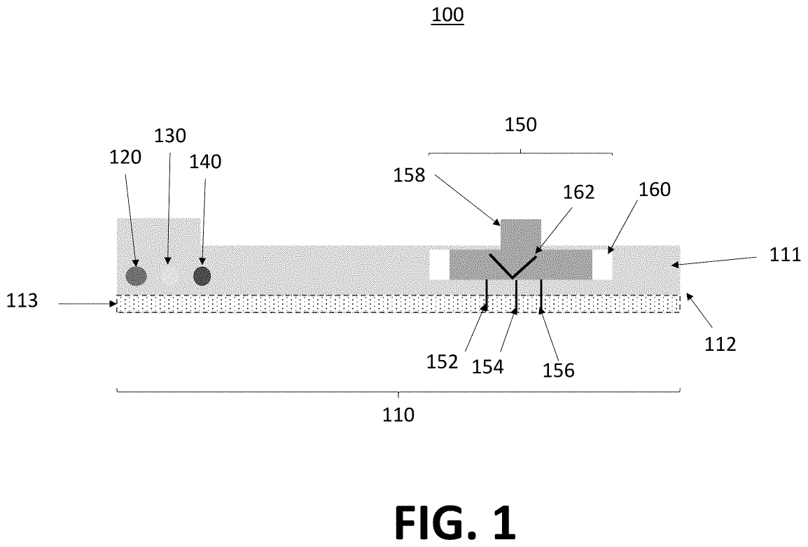

Referring to FIG. 1, an illustrated exemplary rechargeable battery indicator. The rechargeable battery indicator 100 is useful for conveniently indicating the battery charging status and helps a user know the current status and when the battery is nearing required recharging.

The rechargeable battery indicator 100 has a body 110, a first indicator 120, a second indicator 130, a third indicator 140, and an indicator switch 150.

The body 110 of the rechargeable battery indicator 100 has a front 111 and a back 112. The body 110 may have an adhesive on the back 112 of the body 112. The adhesive strip 113 is preferably an adhesive peel sticker, but may be glue, two-sided tape, Velcro, etc. The body is preferably one (1) inch in length and the height of a rechargeable battery.

The back 112 of the body 110 of the rechargeable battery indicator 100 is securely coupled to a side of a rechargeable battery (not shown). The body 110, when adhered to the rechargeable battery, detects and determines the charged level of the rechargeable battery.

The first indicator 120 is a colored or painted location which may indicate a level of charge. The first indicator 120 may be red, green, yellow, etc. The first indicator 120 is preferably recessed into the body 110 of the rechargeable battery indicator 100. The first indicator 120 may be a single color or may be a color which is indicative of a condition of the charge of the rechargeable battery 100.

The second indicator 130 is a colored or painted location. The second indicator 130 may be red, green, yellow, pink, etc. The second indicator 130 is preferably recessed into the body 110 of the rechargeable battery indicator 100. The second indicator 130 may be a single color or may be a color which may be indicative of a condition of the charge of the rechargeable battery 100.

The third indicator 140 is a lamp which may indicate a level of charge. The third indicator 140 may be painted or colored green, yellow, red, etc. The third indicator 140 is preferably recessed into the body 110 of the rechargeable battery indicator 100. The third indicator 140 may be a single color or may be a color which may be indicative of a condition of the charge of the rechargeable battery 100.

The indicator switch 150 has a fully charged position 152, a half-charged level position 154, a depleted position 156 and a tab 158 for manipulating the indicator switch 150 and positioning the indicator to the proper position. The tab 158 of the indicator switch 150 is slidable in a groove 160. The indicator switch 150 of the body 110 of the rechargeable battery indicator 100 may be recessed or may be level with the body 110 of the rechargeable battery indicator 100.

The indicator switch 150 of the body 110 of the rechargeable battery indicator 100 is useful for setting the indicator switch 150 by positioning the position indicator 162 to a fully charged level, a half-charged level, or a depleted level. The setting of the indicator switch 150 to indicate the level allows the user to be quickly determinable of the level of the rechargeable battery and separation between the different level rechargeable batteries.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A rechargeable battery indictor for indicating a battery charge of a rechargeable battery, the rechargeable battery indicator comprising:
a body for attaching to a rechargeable battery, the body having a front side, a back side, a first indicator, a second indicator, a third indicator and an indicator switch;
the first indicator, the first indicator being recessed in the body;
the second indicator; the second indicator being recessed in the body;
the third indicator; the third indicator being recessed in the body;
an indicator switch, wherein the indicator switch having at least three positions;
the indicator switch having a tab, wherein the tab being positioned to indicate the charge level of the rechargeable battery;
the body having an adhesive strip, wherein the adhesive strip being coupled to the back of the body and coupled to the rechargeable battery; and
the body determining the charge level of the rechargeable battery.

2. The rechargeable battery indicator of claim 1, wherein the first indicator being painted.

3. The rechargeable battery indicator of claim 2, wherein the first indicator being painted a green color.

4. The rechargeable battery indicator of claim 1, wherein the second indicator being painted.

5. The rechargeable battery indicator of claim 4, wherein the first indicator being painted a yellow color.

6. The rechargeable battery indicator of claim 1, wherein the third indicator being painted.

7. The rechargeable battery indicator of claim 6, wherein the first indicator being painted a red color.

8. The rechargeable battery indicator of claim 1, wherein the body being made of plastic.

9. The rechargeable battery indicator of claim 1, wherein the at least three positions being “fully charged”, “half-charged” and “depleted.

10. The rechargeable battery indicator of claim 1, wherein the indicator switch being recessed from the body.
